(19) United States
(12) Patent Application Publication
(10) Pub. No.: US 2026/0270535 A1
(43) Pub. Date: Sep. 10, 2026

(54) GENERATIVE TRANSITIONING FOR SEAMLESS MULTIMEDIA SKIPPING

(71) Applicant: GOOGLE LLC, Mountain View, CA (US)

(72) Inventors: Brett Barros, San Mateo, CA (US); Michael Ryan Dorsey, Seattle, WA (US)

(21) Appl. No.: 19/076,177

(22) Filed: Mar. 11, 2025

Related U.S. Application Data
(60) Provisional application No. 63/767,907, filed on Mar. 6, 2025.

(51) Int. Cl. H04N 21/8549; H04N 21/472

(52) U.S. Cl. CPC H04N 21/8549; H04N 21/47217

(57) ABSTRACT

Implementations described herein are directed to utilizing generative model(s) (GM(s)) to summarize portion(s) of multimedia content that are skipped and causing the summarized portion(s) of the multimedia content that are skipped to be rendered as a transition between the skipped portion(s) of the multimedia content. Processor(s) of a system can: receive, during playback of the multimedia content, an indication to skip from a current portion of the multimedia content to a different portion of the multimedia content; process, using a GM, at least a corresponding segment of an intermediate portion of the multimedia content that is between the current portion and the different portion to generate a summary of the intermediate portion; and cause the summary of the intermediate portion to be rendered prior to resuming playback of the multimedia content at the different portion.

### BACKGROUND

Human users (referred to simply as “users”) can utilize computing devices to consume multimedia content in various forms, such as podcasts, audiobooks, music, videos, and/or other forms of multimedia content. Further, users often have control over how they consume the multimedia content. For example, a user can launch a software application at a mobile device and select a podcast to listen to. While listening to the podcast, the user can interact with a scrub bar provided by the software application to skip to a desired portion of the podcast that was previously consumed or that has not yet been consumed. Additionally, or alternatively, some software applications are configured to receive various gestures (e.g., a double tap or the like) to skip forwards or backwards by a predetermined period of time (e.g., 10 second, 15 seconds, etc.).

However, skipping multimedia content can not only be abrupt in terms of the user experience, but it can also take multiple attempts by the user to actually arrive at a desired portion of the multimedia content. Continuing with the above podcast example, if the user skips forward, then any context of an intermediate portion of the podcast between the portion that was being rendered and the portion that the user skips to is lost. As a result, the user may try to skip backwards to obtain the missing context. This wastes computational resources in terms of the mobile device having to process additional user inputs while the user tries to obtain the missing context, and wastes network resources in situations where the podcast is being streamed to the mobile device from a server.

Some efforts have been made to help users skip multimedia content while maintaining the missing context. For instance, some websites and software applications show thumbnails over a scrub bar. These thumbnails can include, for example, a preview of the multimedia content at a given timestamp of the multimedia content, an indication of where certain segments begin and end in the multimedia content, and so on. However, these thumbnails are often provided by a creator or publisher of the multimedia content and fail to provide the user with granular control over the multimedia content, which can result in waste of computational and/or network resources in the same or similar manner described above.

### SUMMARY

Implementations described herein are directed to utilizing generative model(s) (GM(s)) to summarize portion(s) of multimedia content that are skipped and causing the summarized portion(s) of the multimedia content that are skipped to be rendered as a transition between the skipped portion(s) of the multimedia content. Processor(s) of a system can receive, during playback of the multimedia content, an indication to skip from a current portion of the multimedia content to a different portion of the multimedia content. Further, the processor(s) can process, using a GM, GM input to generate GM output. The GM input can include at least a corresponding segment of an intermediate portion of the multimedia content that is between the current portion and the different portion to generate a summary of the intermediate portion. The GM output can include, for example, a probability distribution over a sequence of tokens, such as a sequence of words or words units, a sequence of audio or audio units, a sequence of images or image units, etc. Moreover, the processor(s) can determine, based on the GM output, a summary of the intermediate portion of the multimedia content. Furthermore, the processor(s) can cause the summary of the intermediate portion to be rendered prior to resuming playback of the multimedia content at the different portion. Notably, the GM can be an on-device GM that is executed locally at the client device of the user or a remote GM that is executed remotely from the client device of the user.

Implementations disclosed herein can mitigate (e.g., eliminate) various drawbacks with current techniques. For example, summaries of corresponding segments of intermediate portions of multimedia content can bridge the gap created by abrupt cuts in current skipping methods by providing contextual information and a more natural transition. As another example, unlike static thumbnails, these summaries can be dynamically adapted to the user's specific skip and the corresponding segments of intermediate portions of multimedia content, thereby offering a more personalized and relevant experience. As yet another example, the system's ability to leverage on-device or remote processing allows for efficient generation of these summaries even with diverse media types and varying levels of available information, overcoming the limitations of methods that rely on pre-defined markers or static previews from a creator or publisher of the multimedia content.

As a non-limiting example of some implementations disclosed herein, consider a user listening to a podcast episode about owls. The user is halfway through a monologue about the history of owl research when they decide to skip ahead to a section discussing the impact of global warming on owl populations. Using the disclosed method, the system identifies the skipped segment, which includes the remainder of the monologue. Techniques described herein can process audio from before (the initial part of the monologue) and/or after the skipped section (the segment about global warming). The generated summary can include a brief transitional audio summary, such as: “We were just discussing early owl research, but let's move on to the effects of climate change on owl habitats and populations.” The generated summary can then be rendered prior to resuming the podcast, which smoothly bridges the gap between the two sections and provides the user with necessary context, avoiding the jarring experience of an abrupt cut and eliminating the need for the user to back backwards to obtain the necessary context.

In some implementations, the different portion of the multimedia content can be a future portion of the multimedia content that is subsequent to the current portion of the multimedia content and that has not yet been rendered during the playback of the multimedia content. In some versions of these implementations, the GM input can further include a corresponding segment of the future portion of the multimedia content to help smoothly bridge the gap between the current portion and the future portion. In additional or alternative versions of these implementations, the GM input can further include a corresponding segment of a previous portion of the multimedia content that is prior to the current portion of the multimedia content and that has already been rendered during the playback of the multimedia content to further help smoothly bridge the gap between the current portion and the future portion.

In some implementations, the different portion of the multimedia content can be a previous portion of the multimedia content that is prior to the current portion of the multimedia content and that has already been rendered during the playback of the multimedia content. In some versions of these implementations, the GM input can further include a corresponding segment of the previous portion of the multimedia content to help smoothly bridge the gap between the current portion and the previous portion. In additional or alternative versions of these implementations, the GM input can further include a corresponding segment of a future portion of the multimedia content that is subsequent to the current portion of the multimedia content and that has not yet been rendered during the playback of the multimedia content to further help smoothly bridge the gap between the current portion and the previous portion. In some implementations, the indication to skip from the current portion to the different portion can be based on user actions like dragging a scrub bar, tapping a particular portion of a display of the client device, etc. In some versions of those implementations, a speed at which the user skips the intermediate portion of the multimedia content, a duration of the intermediate portion of the multimedia content that is skipped, and/or content of the intermediate portion of the multimedia content that is skipped can impact whether a summary is generated, a duration of the summary that is generated, and/or content of the summary that is generated.

For example, if the skipped content is determined to be a commercial, advertisement, or other content that is not relevant to understanding the different portion of the multimedia content, then the processor(s) may not generate a summary of the intermediate portion of the multimedia content. Continuing with the above example where the multimedia content is the podcast episode about owls, if a user skips a commercial break in the owl podcast, no transitional audio will be generated, and playback will simply resume at the different portion selected by the user. This avoids unnecessary processing and ensures that the system focuses on generating summaries for content that provides relevant context to the user's listening experience. However, it should be understood that other signals are contemplated herein for determining whether to generate the summary of the multimedia content, such as an amount of detail in the intermediate portion that is skipped, whether content of the intermediate portion is needed to contextualize the different portion, whether the user has previously indicated a desire for summaries of skipped multimedia content or a frequency thereof, whether the user is already familiar with content of the intermediate portion that is skipped, and so on.

Also, for example, longer skipped intermediate portions may necessitate longer summaries, but the processor(s) can potentially summarize only the most relevant segments to the different portion to which the user skipped. Conversely, shorter skipped intermediate portions might only require a brief transitional phrase. Continuing with the above example where the multimedia content is the podcast episode about owls, skipping a lengthy discussion might generally result in a longer summary, but if the lengthy discussion is about owl anatomy, the summary may be relatively shorter since the owl's anatomy is not likely relevant to the subsequent discussion on global warming's impact on owl populations.

Also, for example, the speed at which the user skips through an intermediate portion of multimedia content can influence the length and detail of the generated summary. A fast skip might only warrant a brief transitional phrase, while a slower, more deliberate skip might necessitate a longer, more detailed summary. Conversely, even a fast skip over a lengthy section might still require a longer summary if the skipped content is highly relevant to the different portion. Continuing with the above example of the podcast episode about owls, a quick skip over a lengthy discussion of owl anatomy might only require a short phrase, as owl anatomy is unlikely relevant to the subsequent discussion of global warming's impact on owl populations. However, a slow skip over the same section might result in a longer summary, providing more context for the user.

Additional considerations are contemplated herein with respect to the content of the summary and/or a duration of the summary. For example, the content and/or duration of the summary can be adjusted based on factors like whether the user has consumed the multimedia content before, the type of the multimedia content (podcast, audiobook, video, etc.), and the amount of pre-processing data available for the multimedia content. For instance, a user re-consuming multimedia might not need a detailed summary of skipped portions, whereas a first-time listener of the podcast might benefit from a more thorough recap. Also, for instance, audio-visual multimedia content can include visual elements (e.g., montages, key scenes, or the like) of the skipped portions. In some implementations, the processor(s) can pre-process features of the multimedia content prior to receiving the indication to skip. The features of the multimedia content can be included in the GM input. By pre-processing the features of the multimedia content prior to receiving the indication to skip, techniques described herein can reduce latency in causing the summary of the intermediate portion to be generated and/or rendered. In additional or alternative implementations, the processor(s) can process features of the multimedia content in response to receiving the indication to skip. As noted above, the features of the multimedia content can be included in the GM input. By processing the features of the multimedia content in response to receiving the indication to skip, techniques described herein can consider additional features of the multimedia content that may not have been pre-processed and/or include the most up-to-date features of the multimedia content, thereby resulting in a more accurate and comprehensive summary of the multimedia content.

In some implementations, the features of the multimedia content can be based on, for example, user-based contextual signals that are specific to the user that provided the indication to skip and/or that are specific to a plurality of users (e.g., where the user may or may not be included in the plurality of users). The user-based contextual signals can include, for example, popularity of the corresponding segment of the intermediate portion of the multimedia content, comments related to the corresponding segment of the intermediate portion of the multimedia content, clickthrough rate of the corresponding segment of the intermediate portion of the multimedia content, likes or shares of the corresponding segment of the intermediate portion of the multimedia content, views of the corresponding segment of the intermediate portion of the multimedia content, and/or other user-based contextual signals. Put another way, the user-based contextual signals (or watcher-listener contextual signals) can include information related to the how the user (and/or other users) interact with the multimedia content which can result in the summary being personalized to the user in terms of how the user typically consumes multimedia content.

In additional or alternative implementations, the features of the multimedia content can be based on, for example, content-based contextual signals that are provided by a creator or publisher of the multimedia content. The context-based contextual signals can include, for example, chapterization of the corresponding segment of the intermediate portion of the multimedia content, metadata associated with the corresponding segment of the intermediate portion of the multimedia content (e.g., timestamps, captions, speaker identification, and/or other metadata associated with the corresponding segment of the multimedia content), and/or other content-based contextual signals. Put another way, the content-based contextual signals can include information related to how the creator or publisher of the multimedia content organized and/or provided the multimedia content for consumption, which can result in the summary being personalized to the creator or publisher of the multimedia content in terms of how the creator or publisher would organize and/or provide the multimedia content or the summary thereof. In some implementations, the processor(s) can utilize retrieval augmented generation (RAG) or other processes to obtain content from external data sources to improve the accuracy and/or the content of the summary. For example, and based on content of the intermediate portion of the multimedia content, the processor(s) can determine one or more queries for utilization in obtaining corresponding content that is relevant to the intermediate portion of the multimedia content and obtain content that is relevant to the intermediate portion of the multimedia content based on submission of the one or more queries.

In some versions of those implementations, the processor(s) can select the corresponding segment of the intermediate portion of the multimedia content to be included in the GM input based on the corresponding content that is relevant to the intermediate portion of the multimedia content obtained from the external data sources. Notably, the corresponding segment of the intermediate portion of the multimedia content that is included in the GM input can be the entire intermediate portion of the multimedia content or a subset thereof. For example, the processor(s) can select the corresponding segment of intermediate portion of the multimedia content to be included in the GM input based on the corresponding content (e.g., obtained from the external data sources) verifying factual information about the intermediate portion of the multimedia content, based on the corresponding content (e.g., obtained from the external data sources) identifying trending information about the intermediate portion of the multimedia content, and/or based on other considerations. Put another way, the corresponding content can be utilized to ground the summary with verified and/or trending information about the intermediate portion of the multimedia content.

In some implementations, the processor(s) can provide graphical user interface (GUI) based controls to allow the user to specify features of the summary of the intermediate portion of the multimedia content. The features of the summary of the intermediate portion of the multimedia content can include, for example, a length of the summary of the intermediate portion of the multimedia content, a level of detail of the summary of the intermediate portion of the multimedia content, a modality of the summary of the intermediate portion of the multimedia content, and/or other features of the summary of the intermediate portion of the multimedia content. For instance, a user might choose to have a shorter, less detailed summary or even opt to skip the summary altogether. In this instance, slider(s) could allow the user to adjust the length and/or detail of the generated summary, from a very brief transition to a more comprehensive recap.

Although the above examples are generally described with respect to the multimedia content being a podcast, it should be understood that is for the sake of example and is not meant to be limiting. Rather, it should be understood that the same or similar techniques can be adapted for various types of multimedia content including, but not limited to, audiobooks, videos, music, TV shows, movies, etc. Further, it should be understood that the summary that is provided (e.g., in response to receiving the indication to skip) can be modified or adapted based on the type of the multimedia content that is skipped. For instance, the modality of the summary of the intermediate content may only include audio-based content when the type of multimedia content is audio-based (e.g., audiobook, podcast, music, etc.), whereas the modality of the summary of the intermediate content may only audio-based and visual-based content when the type of multimedia content is audio-based and visual-based (e.g., video, TV show, movie, etc.). Accordingly, it should be understood that generating a summary of intermediate portions of multimedia content for different types of multimedia content are contemplated herein.

The above description is provided as an overview of only some implementations disclosed herein. Those implementations, and other implementations, are described in additional detail herein.

### BRIEF DESCRIPTION OF THE DRAWINGS

FIG. 1 depicts a block diagram of an example environment that demonstrates various aspects of the present disclosure, and in which implementations disclosed herein can be implemented.

FIG. 2 depicts a process flow for utilizing various components from the example environment of FIG. 1, in accordance with various implementations.

FIG. 3 depicts a flowchart illustrating an example method of generating a summary of an intermediate portion of multimedia content that is skipped, in accordance with various implementations.

FIG. 4A, FIG. 4B, FIG. 4C, and FIG. 4D depict various non-limiting examples of generating a summary of an intermediate portion of multimedia content that is skipped, in accordance with various implementations.

FIG. 5 depicts an example architecture of a computing device, in accordance with various implementations.

### DETAILED DESCRIPTION

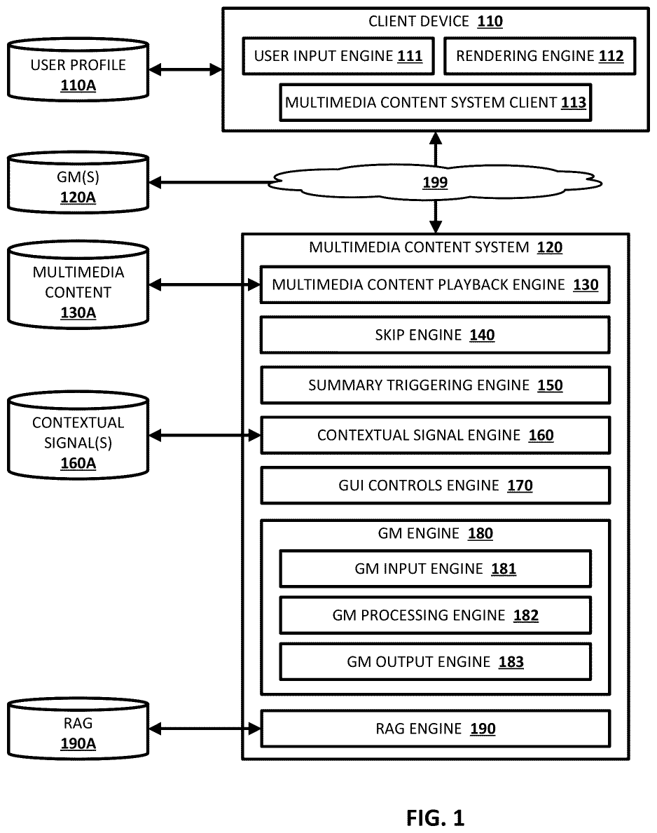

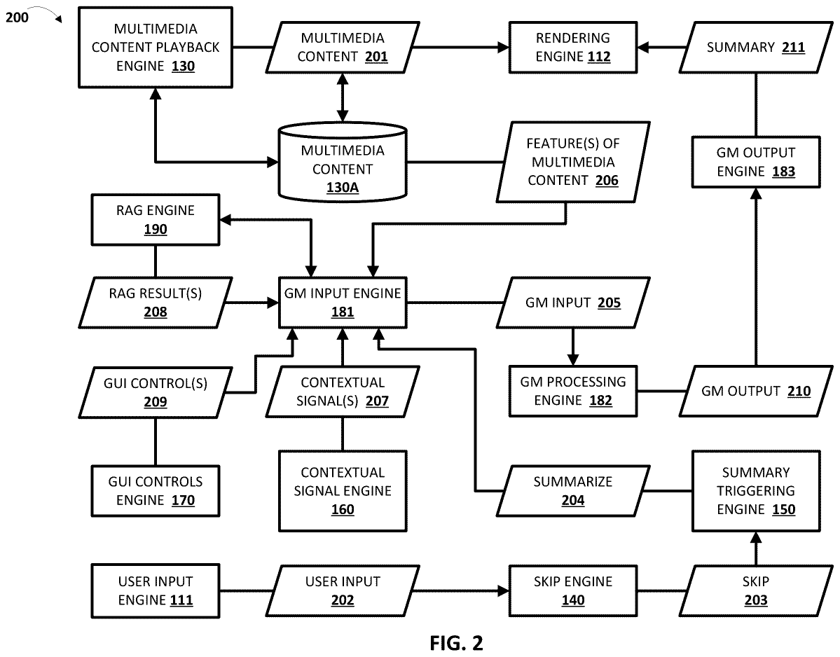

Turning now to FIG. 1, a block diagram of an example environment that demonstrates various aspects of the present disclosure, and in which implementations disclosed herein can be implemented is depicted. A client device 110 is illustrated in FIG. 1, and includes, in various implementations, a user input engine 111, a rendering engine 112, and a multimedia content system client 113. The client device 110 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, a video game console, and/or a wearable apparatus of the user that includes a computing device (e.g., a watch of the user having a computing device, glasses of the user having a computing device, a virtual or augmented reality computing device, etc.). Additional and/or alternative client devices may be provided.

The user input engine 111 can detect various types of user input at the client device 110. In some examples, the user input detected at the client device 110 can include spoken utterance(s) of a human user of the client device 110 that is detected via microphone(s) of the client device 110. In these examples, the microphone(s) of the client device 110 can generate audio data that captures the spoken utterance(s). In other examples, the user input detected at the client device 110 can include touch input of a human user of the client device 110 that is detected via user interface input device(s) (e.g., touch sensitive display(s), remote control(s), computer mouse(s), and/or stylus(es)) of the client device 110, and/or typed input detected via user interface input device(s) (e.g., touch sensitive display(s) and/or keyboard(s)) of the client device 110. In these examples, the user interface input device(s) of the client device 110 can generate textual data that captures the touch input and/or the typed input. In other examples, the user input detected at the client device 110 can include vision-based input of a human user of the client device 110 that is detected via vision component(s) (e.g., camera(s)) of the client device 110.

The rendering engine 112 can cause content and/or other output to be visually rendered for presentation to the user at the client device 110 (e.g., via a touch sensitive display or other user interface output device(s)) and/or audibly rendered for presentation to the user at the client device 110 (e.g., via speaker(s) or other user interface output device(s)). The content and/or other output can include, for example, a summary of multimedia content that is skipped by a user of the client device 110, notifications, selectable graphical elements, and/or any other content and/or output described herein.

The client device 110 is illustrated in FIG. 1 as communicatively coupled to a multimedia content system 120 over one or more networks 199 (e.g., any combination of WiFi, Bluetooth, or other local area networks (LANs); ethernet, the Internet, or other wide area networks (WANs); and/or any other wired or wireless networks). The multimedia content system 120 can be implemented by, for example, a high-performance server, a cluster of high-performance servers, and/or any other computing device that is remote from the client device 110. The multimedia content system 120 includes, in various implementations, a multimedia content playback engine 130, a skip engine 140, a summary triggering engine 150, a contextual signal engine 160, a graphical user interface (GUI) controls engine 170, a GM engine 180, and a retrieval augmentation generation (RAG) engine 190. The GM engine 180 can include various sub-engines, such as a GM input engine 181, a GM processing engine 182, and a GM output engine 183. Although FIG. 1 is depicted with respect to certain engines and sub-engines, it should be understood that is for the sake of example and is not meant to be limiting. For example, one or more of the engines and/or sub-engines depicted in FIG. 1 can be combined and/or omitted.

The client device 110 and/or the multimedia content system 120 can access various databases and/or systems. For instance, the client device 110 and/or the multimedia content system 120 can access user profile database 110A that stores user profile data as described herein, GM(s) database 120A that stores one or more GMs as described herein, multimedia content database 130A that stores various features of multimedia content that has been pre-processed, contextual signal(s) database 160A that stores, for a given instance of multimedia content, user-based contextual signals and/or content-based contextual signals as described herein, and/or RAG database 190A that can serve as an external data source for obtaining content that is relevant to a given instance of multimedia content (or a portion thereof). However, it should be understood that, in various implementations, one or more of the databases may be access-restricted. For instance, in some implementations, the multimedia content system 120 may not have access to the user profile database 110A (e.g., when the multimedia content system 120 is implemented remotely from the client device 110A). Although FIG. 1 is depicted with respect to certain databases and systems, it should be understood that is for the sake of example and is not meant to be limiting. For example, one or more of the databases and/or systems depicted in FIG. 1 can be combined and/or omitted.

Moreover, the client device 110 can execute the multimedia content system client 113. An instance of the multimedia content system client 113 can be an application that is separate from an operating system of the client device 110 (e.g., installed “on top” of the operating system)—or can alternatively be implemented directly by the operating system of the client device 110. The multimedia content system client 113 can communicate with the multimedia content system 120 via one or more of the networks 199 (e.g., as shown in FIG. 1). It should be understood that the multimedia content system client 113 can implement the multimedia content system 120 locally at the client device 110 via the multimedia content system client 113. However, it should also be understood that one or more aspects of the multimedia content system 120 can be implemented remotely from the client device 110 (e.g., exclusively at a high-performance server or cluster of high-performance servers), or both remotely the multimedia content system 120 and locally the client device 110 (e.g., via the multimedia content system client 113) in a distributed manner.

Furthermore, the client device 110 and/or the multimedia content system 120 may include one or more memories for storage of data and software applications, one or more processors for accessing data and executing the software applications, and other components that facilitate communication over one or more of the networks 199. In some implementations, one or more of the software applications can be installed locally at the client device 110, whereas in other implementations one or more of the software applications can be hosted remotely from the client device 110 (e.g., by one or more servers), but accessible by the client device 110 over one or more of the networks 199.

Although FIG. 1 is described with respect to a single client device having a single user, it should be understood that is for the sake of example and is not meant to be limiting. For example, one or more additional client devices of a user can also implement the techniques described herein. For instance, the client device 110, the one or more additional client devices, and/or any other computing devices of the user can form an ecosystem of devices that can employ techniques described herein. These additional client devices and/or computing devices may be in communication with the client device 110 and/or the multimedia content system 120 (e.g., over the one or more networks 199). As another example, a given client device can be utilized by multiple users in a shared setting (e.g., a group of users, a household, etc.).

As described herein, a GM can be any sequence-to-sequence based machine learning model capable of generating generative vision data, generative audio data, generative textual data, and/or other forms of generative data. Some non-limiting examples of sequence-to-sequence based machine learning models that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, etc. Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.).

As described in more detail herein, the multimedia content system 120 can be utilized to generate transitional audio/video content bridging skipped portions of multimedia content. This multimedia content system 120 can employ a GM to create summaries of the skipped portions, using input data including segments of the skipped portions (and optionally portions of the multimedia content that are before and/or after the skipped portion), contextual signals (e.g., user-based contextual signals and/or content-based contextual signals), features or the skipped portions of the multimedia content. The summary can be rendered before resuming playback at the selected point, providing contextual information and a smooth transition, thereby obviating instances of the user having to manually re-skip to another portion of the multimedia content to obtain this contextual information. The multimedia content system 120 can adapt the summary's length and detail based on factors such as user history, a type of the multimedia content, available pre-processing data, available processing bandwidth, etc. Furthermore, the system can leverage on-device and/or remote GMs and incorporate external data sources for enhanced context and accuracy. Additional description of the multimedia content playback engine 130, the skip engine 140, the summary triggering engine 150, the contextual signal engine 160, the GUI controls engine 170, the GM engine 180, and the RAG engine 190 is provided herein (e.g., with respect to FIGS. 2, 3, and 4A-4D).

Turning now to FIG. 2, a process flow 200 for utilizing various components from the example environment of FIG. 1 is depicted. For the sake of example, assume that the multimedia content playback engine 130 is causing multimedia content 201 to be played back at the client device 110 via the rendering engine 112. The multimedia content 201 can be audio-based, visual-based, augmented reality-based, virtual reality-based, or any combination thereof. Further, during playback of the multimedia content 201, assume that the user input engine 111 detects user input 202 and assume that skip engine 140 determines the user input 202 is an indication to skip 203 from a current portion of the multimedia content 201 to a different portion of the multimedia content 201. Moreover, assume that the summary triggering engine 150 determines to summarize 204 an intermediate portion of the multimedia content 201 that is between the current portion of the multimedia content 201 and the different portion of the multimedia content 201.

In some implementations, the summary triggering engine 150 can process content of the intermediate portion of the multimedia content 201 and/or metadata associated with the intermediate portion of the multimedia content 201 (e.g., using a GM or other machine learning model) to determine whether to generate the summary. For example, if the skipped content (e.g., the intermediate portion of the multimedia content 201) is determined to be a commercial or advertisement, then the summary triggering engine 150 may determine to not summarize the skipped content. As another example, if the skipped content (e.g., the intermediate portion of the multimedia content 201) is determined to be not relevant to understanding the different portion of the multimedia content, then the summary triggering engine 150 may determine to not summarize the skipped content. Otherwise, the summary triggering engine 150 may determine to summarize the skipped content.

The GM input engine 181 can generate GM input 209 for utilization in generating a summary of the intermediate portion of the multimedia content 201. In implementations where the summary triggering engine 150 is utilized to determine whether to generate the summary of the intermediate portion of the multimedia content 201, the GM input engine 181 may only generate the GM input 205 in response to receiving the indication to summarize 204. Otherwise, the GM input engine 150 may generate the GM input 205 in response to receiving the indication to skip 203 from the current portion of the multimedia content 201 to the different portion of the multimedia content 201.

Notably, the GM input 201 can include at least a corresponding segment of the intermediate portion of the multimedia content 201 that is between the current portion of the multimedia content 201 and the different portion of the multimedia content 201 to generate the summary of the intermediate portion of the multimedia content 201 (e.g., all of the intermediate portion or a subset thereof). The corresponding segment of the intermediate portion of the multimedia content 201 can be received as one or more features of the multimedia content 206 (e.g., stored in the multimedia content database 130A, stored a multimedia content buffer at the client device 110, or stored in a multimedia content buffer at the multimedia content system 120). However, in various implementations, the GM input 205 can include additional information.

For example, in some implementations, the GM input 205 can include one or more additional features of the multimedia content 205 that are received along with the corresponding segment of the intermediate portion of the multimedia content 201. These additional features of the multimedia content 205 can include prior portions of the multimedia content 201 that precede the intermediate portion, providing context for the intermediate portion that is skipped. Additionally, or alternatively, these additional features of the multimedia content 205 can include future portions of multimedia content 201 that are subsequent to the intermediate portion, allowing for a smoother transition and preview of what's next. Put another way, one or more of the additional features of the multimedia content 205 allows the GM to create a more comprehensive and relevant summary of the skipped content, bridging the gap between the current and target points in the multimedia content 201.

As another example, in additional or alternative implementations, the GM input 205 can include one or more contextual signals 207 provided by the contextual signal engine 160 (and optionally stored in the contextual signal(s) database 160A), such as one or more user-based contextual signals that are specific to user(s) that consume the multimedia content 201, one or more content-based contextual signals that are provided by a creator or publisher of the multimedia content 201, and/or other contextual signals.

Notably, user-based contextual signals can include, for example, popularity of the intermediate portion, comments related to the intermediate portion, click-through rates for the intermediate portion (and optionally relative to the multimedia content 201 as a whole), likes of the multimedia content 201, shares of the multimedia content 201, views of the multimedia content 201, and/or other contextual signals related to the multimedia content 201 and based on how the user(s) interact with or otherwise consume the multimedia content 201. These user-based contextual signals can impact the summary of the intermediate portion by influencing the length and detail of the generated summary, prioritizing information from highly engaging sections, etc.

Further, content-based contextual signals can include, for example, chapter markers and metadata (timestamps, captions, speaker identification), and/or other contextual signals provided by the creator or publisher of the multimedia content 201 that offer structural and semantic information about the multimedia content 201. These content-based contextual signals can impact on the summary of the intermediate portion by guiding the generative model to create a more accurate and contextually relevant summary, respecting the creator's or publisher's intended structure and highlighting key information.

As another example, in additional or alternative implementations, the GM input 205 can include one or more RAG results 208 that are obtained by the RAG engine 190 (and optionally from RAG database 190A). In some implementations, the GM input engine 181 can determine to obtain one or more of the RAG results 208 to ground the summary in search results, to determine trending topics in the intermediate portion, and so on. In these implementations, the RAG engine 1910 can determine one or more search queries based on the intermediate portion, and obtain the content included in one or more of the RAG results 208 based on submitting one or more of the search queries. By using one or more of the RAG results 208, the GM input engine 181 can generate the GM input that, when processed, forces the summary to be grounded in factual information, to highlight newsworthy information, etc. while also ensuring the transition is smooth and contextually relevant, particularly when dealing with current events or rapidly evolving information.

As another example, in additional or alternative implementations, the GM input 205 can include one or more GUI controls 209 that are provided by the GUI controls engine 170. For example, when the initially provides the indication to skip the intermediate portion of the multimedia content 201, the user can be provided with various GUI controls that can enable the user to further personalize the summary. For example, slider controls can be provided to adjust the summary length, dropdown menus can be provided to select the summary's detail level (brief, detailed, etc.), checkboxes can be provided to allow users to choose the summary's modality (audio, visual, or both), toggle switches can be provided to enable or disable the summary feature entirely. These controls are received as user inputs (e.g., detected via the user input engine 111 and passed to the GUI controls engine 170), processed to extract relevant parameters, and translated into instructions for the GM, specifying the desired summary characteristics that the GM must adhere to in generating the summary.

The GM processing engine 182 can process, using a GM, the GM input 205 to generate GM output 210. The GM output can include, for example, one or more probability distributions over a respective sequence of tokens that may vary based on a desired modality of the summary. For example, for text-based summaries, the probability distribution could be over a sequence of words or word units, representing the likelihood of different wordings for a concise recap of the skipped content. As another example, for audio-based summaries, the probability distribution could be over a sequence of phonemes or spectrograms, generating a synthesized audio bridge that smoothly connects the skipped segments. As another example, for vision-based summaries, the probability distribution could be over a sequence of image features or scene representations, creating a montage or collage of key visual elements from the skipped portion.

In various implementations, such as when the summaries are multimodal, the distribution could encompass sequences of words, audio segments, and image features, generating a coherent summary integrating all modalities. For generative multimedia content, the probability distribution could additionally, or alternatively, be conditioned on the underlying reference material, ensuring the generated summary aligns with the original content's structure and style (e.g., by including the underlying reference material in the GM input 205).

The GM output engine 183 can determine, based on the GM output 210, a summary 211 of the intermediate portion of the multimedia content 201 and cause the summary 211 to be audibly and/or visually rendered at the client device 110 via the rendering engine 112. For example, the GM output engine 183 can decode the one or more probability distributions over the respective sequences of tokens by selecting the most probable sequence of tokens based on the probability distributions, which are then assembled into a coherent summary. The resulting summary can be optimized for natural language flow, audio coherence, or visual continuity, depending on the media type.

Upon causing the summary 211 of the intermediate portion of the multimedia content 201, the multimedia content playback engine 130 can resume playback of the multimedia content 201 from the different portion. Notably, users can skip forwards and backwards relatively quickly. Accordingly, in various implementations, the multimedia content system 120 can prioritize utilization of an on-device GM (e.g., that is hosted locally at the client device 110) to generate the summary over utilizing a remote GM (e.g., that is hosted remotely from the client device 110). This can further reduce latency in causing the summary 211 to be rendered. However, it should be understood that the remote GM can be utilized in various implementations without departing from the scope of the present disclosure.

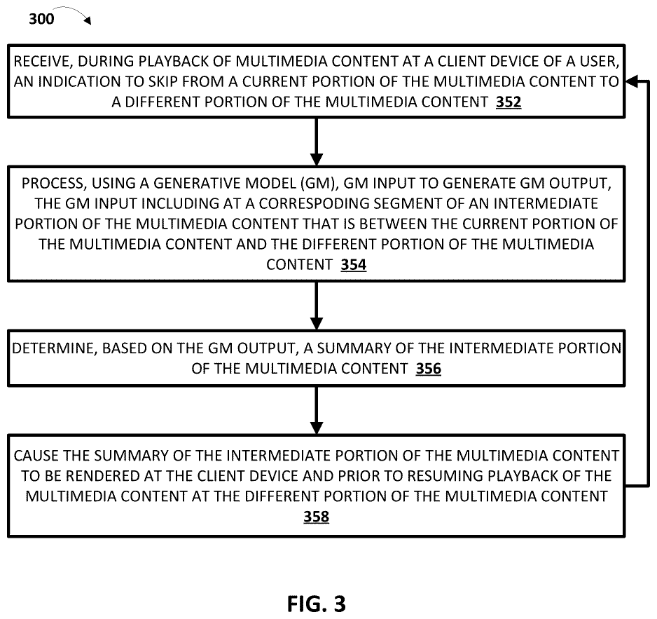

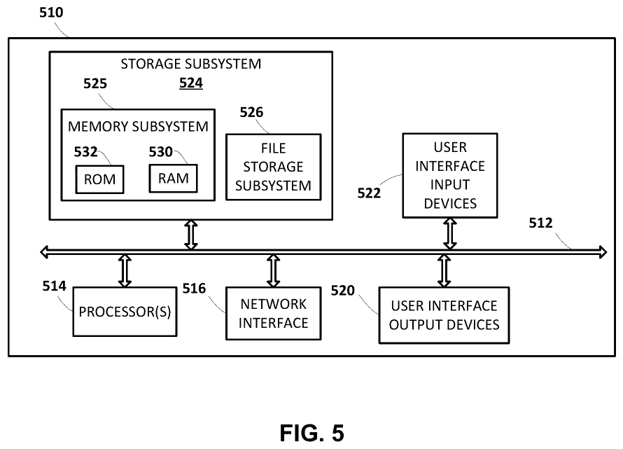

Turning now to FIG. 3, a flowchart illustrating an example method 300 of generating a summary of an intermediate portion of multimedia content that is skipped is depicted. For convenience, the operations of the method 300 are described with reference to a system that performs the operations. This system of the method 300 includes at least one processor, memory, and/or other component(s) of computing device(s) (e.g., the client device 110 of FIG. 1 via the multimedia content system client 113, the multimedia content system 120 of FIG. 1, the computing device 510 of FIG. 5, and/or other computing device.). Moreover, while operations of the method 300 are shown in a particular order, this is not meant to be limiting. One or more operations may be reordered, omitted, and/or added.

At block 352, the system receives, during playback of multimedia content at a client device of a user, an indication to skip from a current portion of the multimedia content to a different portion of the multimedia content. For example, the system can cause the multimedia content playback engine 130 to determine that multimedia content is being played back at the client device, and can cause the skip engine 140 to determine that user input was received to skip from the current portion to the different portion (e.g., as described with respect to FIG. 2).

At block 354, the system processes, using a generative model (GM), GM input to generate GM output, the GM input including at least a corresponding segment of an intermediate portion of the multimedia content that is between the current portion of the multimedia content and the different portion of the multimedia content. At block 356, the system determines, based on the GM output, a summary of the intermediate portion of the multimedia content. For example, the system can cause the GM input engine 181 to generate the GM input, the system can cause the GM processing engine 182 to process, using the GM, the GM input to generate the GM output, and the system can cause the GM output engine 183 to decode the GM output to generate the summary (e.g., as described with respect to FIG. 2). In various implementations, and prior to generating the summary of the intermediate content, the system can cause the summary triggering engine 150 to determine whether to generate the summary (e.g., based on content of the intermediate portion and/or based on user controls received via the GUI controls engine).

Notably, the GM input can include additional information beyond just the corresponding segment of the intermediate portion of the multimedia content. In various implementations, the system can cause the contextual signal engine 160 to provide various contextual signals to the GM input engine 181 for inclusion in the GM input to further contextualize the summary (e.g., user-based contextual signals and/or content-based contextual signals as described with respect to FIG. 2). In various implementations, the system can cause the GUI controls engine 170 to provide various summary control signals to the GM input engine 181 for inclusion in the GM input to further personalize the summary (e.g., a length or duration of the summary, a level of detail of the summary, etc.). In various implementations, the system can cause the RAG engine 190 to provide RAG result(s) to the GM input engine 181 for inclusion in the GM input to ground the summary in verifiable facts, to focus on trending topics in the intermediate portion, etc.

At block 358, the system causes the summary of the intermediate portion of the multimedia content to be rendered at the client device and prior to resuming playback of the multimedia content at the different portion of the multimedia content. The system can cause the summary of the intermediate portion to be audibly and/or visually rendered at the client device of the user. Further, and subsequent to causing the summary of the intermediate portion to be audibly and/or visually rendered at the client device of the user, the system can cause playback of the multimedia content to be resumed at the client device and at the different portion of the multimedia content to which the user skipped.

The system returns to block 352 and performs an additional iteration of the method 300 in response to receiving at least an additional indication to skip from an additional current portion of the multimedia content to an additional different portion of the multimedia content. Accordingly, the user can continue to skip (e.g., forwards or backwards) from current portions of the multimedia content that are being consumed to different portions of the multimedia content until playback of the multimedia content ends.

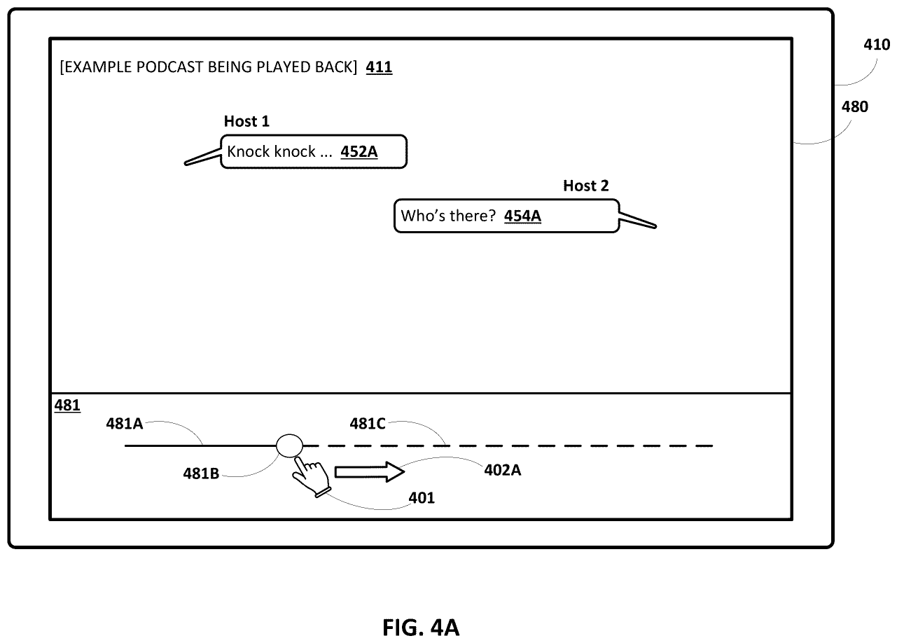

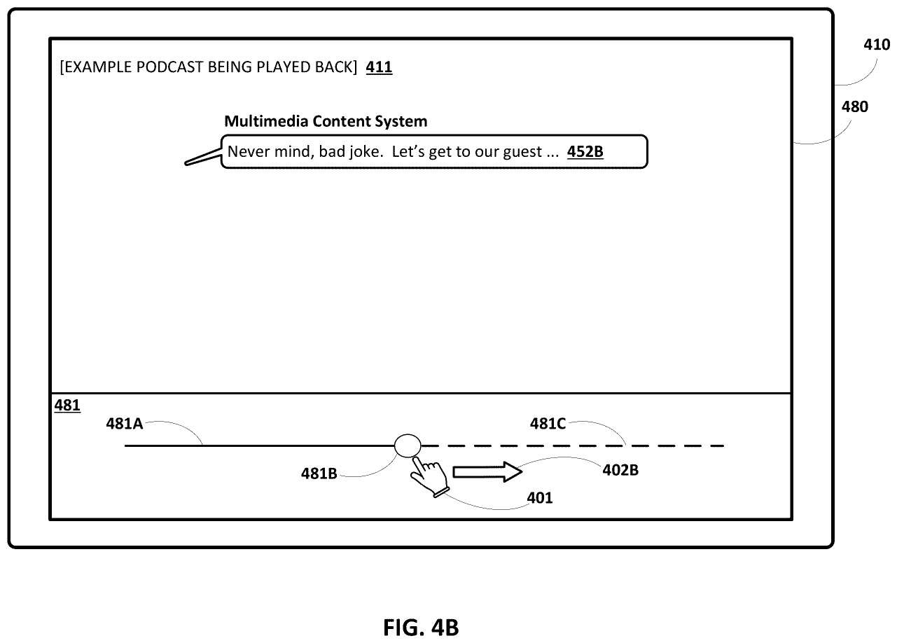

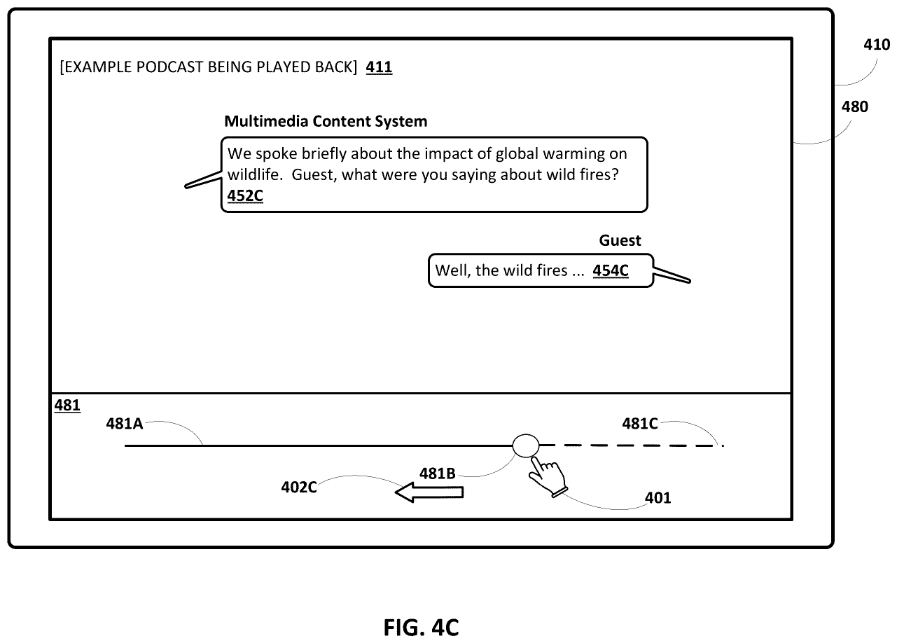

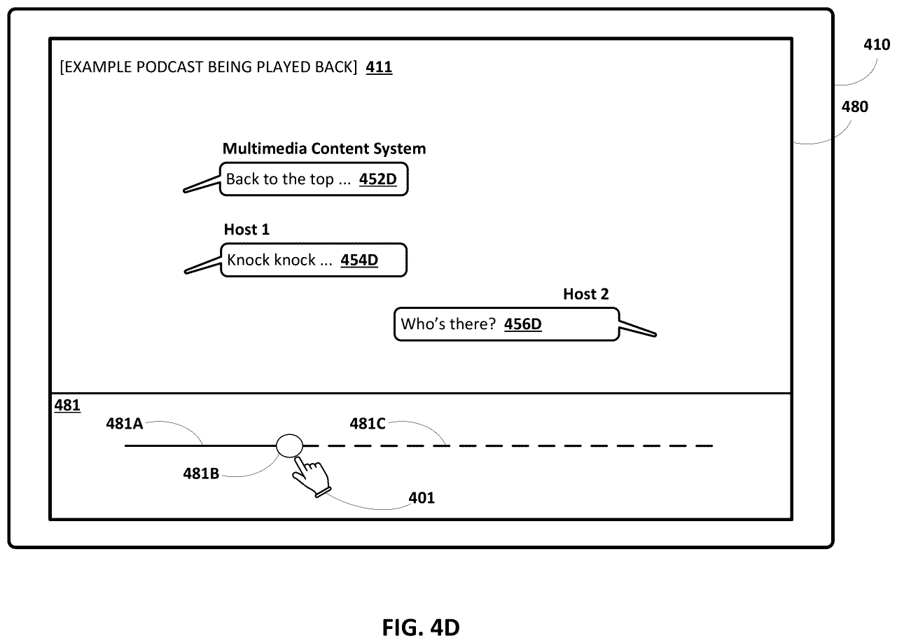

Turning now to FIGS. 4A, 4B, 4C, and 4D, various non-limiting examples of generating a summary of an intermediate portion of multimedia content that is skipped are depicted. FIGS. 4A, 4B, 4C, and 4D, each depict a client device 410 (e.g., an instance of the client device 110 from FIG. 1) having a display 480. Although the client device 110 of FIGS. 4A, 4B, 4C, and 4D is depicted as a mobile phone having a touch-sensitive display, it should be understood that is not meant to be limiting. The client device 110 can be, for example, a stand-alone assistant device (e.g., with speaker(s) and/or a display), a laptop, a desktop computer, a wearable computing device (e.g., a smart watch, smart headphones, etc.), a vehicular computing device, a game console, and/or any other client device capable of accepting various types of user inputs from different components.

For the sake of example throughout FIGS. 4A, 4B, 4C, and 4D, assume that an example podcast (e.g., multimedia content) is being played back at the client device 410 as indicated at 411. Further assume that a scrub bar 481 associated with playback of the example podcast is provided at the display 480 of the client device 410. In some implementations, the scrub bar 481 may persist at the display 480 of the client device 410 while the example podcast is being played back whereas, in other implementations, the scrub bar 481 may only be displayed when the user provides some form of user input to view the scrub bar 481 (e.g., a single tap directed to the display 480 of the client device 410, dragging up on a bottom portion of the display 480 of the client device 410, etc.). The scrub bar 481 can enable the user to view how much of the example podcast has been rendered and/or consumed (e.g., as indicated by previous portion of multimedia content 481A), a current portion of the example podcast that is being rendered and/or consumed (e.g., as indicated by current portion of multimedia content 481B), and how much of the example podcast that is yet to be rendered and/or consumed (e.g., as indicated by future portion of multimedia content 481C). Further, the scrub bar 481 can enable the user to skip different portions of the example podcast as desired.

Referring specifically to FIG. 4A, assume that the podcast has multiple hosts and a guest. Further assume that a first host (e.g., “Host 1”) provides a spoken utterance including a segment of multimedia content 452A of “Knock knock . . . ”, and a second host (e.g., “Host 2”) provides a spoken utterance including a segment of multimedia content 454A of “Who's there?”.

In the example of FIG. 4A, and upon playback of the segment of multimedia content 454A, assume that the user of the client device 410 directs touch input to the scrub bar 481 as indicated by 401 and skips forward in the example podcast as indicated by 402A. In this example, the difference between the current portion of multimedia content 481B shown in FIG. 4A and the current portion of multimedia content 481B shown in FIG. 4B can correspond to an intermediate portion of the example podcast for which a summary can be generated.

Referring specifically to FIG. 4B, and rather than simply resuming the example podcast at the different portion of the multimedia content to which the user skipped, a multimedia content system (e.g., the multimedia content system 120 of FIG. 1 and/or the multimedia content system client 113 of FIG. 1) can generate the summary of the intermediate portion of the example podcast using a GM.

For instance, assume that the intermediate portion of the multimedia content included the remainder of the knock knock joke in FIG. 4A and an initial portion of an introduction of the guest of example podcast. In this instance, and as shown in FIG. 4B, the multimedia content system can generate (e.g., as described in FIGS. 2 and/or 3) a summary of multimedia content 452B of “Never mind, bad joke. Let's get to our guest . . . ”, and then playback of the example podcast can resume at the current portion of multimedia content 481B shown in FIG. 4B.

In generating the summary of multimedia content 452B, the GM input that is processed can include audio and/or text corresponding to at least the intermediate portion. The GM input can optionally further include audio and/or text corresponding to segment(s) of the previous portion of multimedia content 481A shown in FIG. 4B; audio and/or text corresponding to segment(s) of the future portion of multimedia content 481C shown in FIG. 4B; any relevant contextual signals for the user; any relevant contextual signals for example podcast; and/or other information described herein in relation to the GM input.

In the example of FIG. 4B, and upon rendering of the summary of multimedia content 452B or upon resumption at the current portion of multimedia content 481B shown in FIG. 4B, assume that the user of the client device 410 directs touch input to the scrub bar 481 as indicated by 401 and skips forward in the example podcast as indicated by 402B. In this example, the difference between the current portion of multimedia content 481B shown in FIG. 4B and the current portion of multimedia content 481B shown in FIG. 4C can correspond to an intermediate portion of the example podcast for which a summary can be generated.

Notably, in the example of FIG. 4B, the summary of multimedia content 452B of “Never mind, bad joke. Let's get to our guest . . . ” is not strictly a summary in the sense that the knock knock joke is not summarized and included in the summary of multimedia content 452B. Accordingly, the summary of multimedia content described herein is not limited to actual or exact summarization of the content that is skipped. Rather, in various implementations, it should be understood that the summary of multimedia content can additionally, or alternatively, serve as a transition to bridge between where the skipped from to where the user skipped to, re-iterate content that has already been consumed and that is relevant to where the user skipped to, foreshadow content of where the user skipped to, and so on. Further, in various implementations, the summary of multimedia content described herein may be further based on various contextual signals described herein.

Referring specifically to FIG. 4C, and rather than simply resuming the example podcast at the different portion of the multimedia content to which the user skipped, the multimedia content system can generate the summary of the intermediate portion of the example podcast and using a GM.

For instance, assume that the intermediate portion of the multimedia content included an overview from the guest on how global warming can impact wildlife. In this instance, and as shown in FIG. 4C, the multimedia content system can generate (e.g., as described in FIGS. 2 and/or 3) a summary of multimedia content 452C of “We spoke briefly about the impact of global warming on wildlife. Guest, what were you saying about the fires?”, and then playback of the example podcast can resume at the current portion of multimedia content 481B shown in FIG. 4C and as indicated by 456C.

In generating the summary of multimedia content 452C, the GM input that is processed can include audio and/or text corresponding to at least the intermediate portion. The GM input can optionally further include audio and/or text corresponding to segment(s) of the previous portion of multimedia content 481A shown in FIG. 4C; audio and/or text corresponding to segment(s) of the future portion of multimedia content 481C shown in FIG. 4C; any relevant contextual signals for the user; any relevant contextual signals for example podcast; any RAG results to verify claims made by the guest; and/or other information described herein in relation to the GM input.

In the example of FIG. 4C, and upon rendering of the summary of multimedia content 452C or upon resumption at the current portion of multimedia content 481B shown in FIG. 4C, assume that the user of the client device 410 directs touch input to the scrub bar 481 as indicated by 401 and skips backwards in the example podcast as indicated by 402C. In this example, the difference between the current portion of multimedia content 481B shown in FIG. 4C and the current portion of multimedia content 481B shown in FIG. 4D can correspond to an intermediate portion of the example podcast for which a summary can be generated.

Referring specifically to FIG. 4D, and rather than simply re-summarizing what the user has already consumed and/or summarized, the multimedia content system can generate the summary of the intermediate portion of the example podcast and using a GM, but omit certain aspects from the summary.

For instance, in the example of FIG. 4D, the user has skipped back to the initial dialog between the two hosts where the first host provides a spoken utterance including a segment of multimedia content 454D of “Knock knock . . . ”, and the second host provides a spoken utterance including a segment of multimedia content 456D of “Who's there?”. Accordingly, rather than generating a summary that acknowledges the knock joke or that provides an overview of the interview with the guest, the interview with the guest, the multimedia content system can generate (e.g., as described in FIGS. 2 and/or 3) a summary of multimedia content 452D of “Back to the top . . . ”, and then playback of the example podcast can resume at the current portion of multimedia content 481B shown in FIG. 4D and as indicated by 454D.

In generating the summary of multimedia content 452D, the GM input that is processed can include audio and/or text corresponding to at least the intermediate portion and at least relevant contextual signals for the user indicating that the intermediate portion has already been consumed by the user and/or has already been summarized for the user. The GM input can optionally further include audio and/or text corresponding to segment(s) of the previous portion of multimedia content 481A shown in FIG. 4D; audio and/or text corresponding to segment(s) of the future portion of multimedia content 481C shown in FIG. 4D; any other relevant contextual signals for the user; any relevant contextual signals for example podcast; and/or other information described herein in relation to the GM input.

In various implementations, the multimedia content system can utilize speaker identification features to tailor the summary to a specific speaker. These speaker identification features can be included in metadata that is associated with the multimedia content (e.g., as content-based contextual signals) or determined based on processing the multimedia content. For example, if the skipped content is a monologue by the first host, the summary can be generated using a voice profile of the first host. Similarly, if the skipped section involves an interview with a guest, the summary can be generated using a voice profile of the guest. This personalized approach ensures a more natural and engaging transition for the summary. The multimedia content system can also adapt the style and tone of the summary to match the speaker, creating a seamless integration with the surrounding content. For instance, a humorous segment skipped by the user might be summarized with a lighthearted tone, while a serious discussion might be summarized with a more formal tone.

In some implementations, this speaker-specific summary generation is performed in real-time using the GM, leveraging the audio and/or video buffer for immediate context. This approach minimizes latency and provides a responsive user experience, especially crucial for live streaming or on-demand content where quick transitions are desired. The multimedia content system can dynamically analyze the audio stream to identify speakers and select the appropriate voice profile for generating the summary.

In other implementations, speaker identification is performed as a post-processing step after the GM has processed the skipped content. This approach allows for more complex analyses of the audio and/or video data, potentially using other machine learning models (e.g., that are in addition to the GM that generates the summary) to refine speaker identification and improve the accuracy of voice profile selection. This method may be preferred for offline processing or for scenarios where latency is less critical, allowing for a more thorough analysis of the skipped content. The multimedia content system can also use this post-processing step to enhance the quality of the generated summary, for example, by adjusting the pacing, intonation, or emphasis of the generated speech to better match the original speaker's style.

In some implementations, the system can seamlessly switch between different speaker voices within a single summary if the skipped section contains multiple speakers. This ensures that the generated summary accurately reflects the conversation flow and avoids any confusion for the user. The multimedia content system can utilize advanced techniques such as speaker diarization and voice cloning to create a highly realistic and contextually accurate summary, regardless of the number of speakers involved in the skipped section.

In some implementations, the multimedia content system can leverage speaker identification to prioritize certain segments of the skipped content for inclusion in the summary. For example, if the skipped section contains multiple speakers, the system can prioritize the segments spoken by the main protagonist or the most important character in the narrative. This approach ensures that the generated summary focuses on the most relevant information and avoids unnecessary details. The multimedia content system can also use speaker identification to detect changes in speaker roles or conversational dynamics, which can be used to create a more nuanced and engaging summary.

Although the examples of FIGS. 4A-4D do not depict any GUI controls, it should be understood that is for the sake of brevity and is not meant to be limiting. For instance, slider controls could allow the user to adjust the length of the generated summary, dropdown menus could allow the user to select the summary's detail level (brief, detailed, etc.), and checkboxes could allow the user to choose the summary's modality (audio, visual, or both). Toggle switches could enable or disable the summary feature entirely. These controls would allow for a personalized experience, enabling the user to balance the trade-off between a fast skip and a well-contextualized transition. Haptic feedback could also be used to highlight potential jump points, making the skipping process more intuitive and efficient.

Although the examples of FIGS. 4A-4D are described with respect to the user skipping the multimedia content via a scrub bar, it should be understood that is for the sake of example and is not meant to be limiting. Rather, it should be understood that, in various implementations, additional or alternative means for skipping the multimedia content can be provided. For instance, double tap gestures can be implemented to skip forward or backward by predetermined durations, such as 15 seconds or the like, or by semantic boundaries of the multimedia content, such as between content segments, between speaker segments, between sentence boundaries, or the like. Other input methods, like button presses or voice commands, could also trigger these generative skips. These alternative input methods provide users with flexible control over how they navigate multimedia content.

Although the examples of FIGS. 4A-4D are described with respect to the multimedia content being the example podcast, it should be understood that is for the sake of example and is not meant to be limiting. Rather, it should be understood that the same or similar techniques can be utilized to generate summaries for skipping different types of multimedia content. These different types of multimedia content include, for example, audiobooks, music, videos, TV shows, movies, and/or other forms of multimedia content.

For example, in implementations where the multimedia content is an audiobook, the chapterization of the audiobook acts as a content-based contextual signal that can be included in GM input. FIGS. 4A-4D could be adapted by replacing the podcast segments with audiobook chapters. The generative model would use the chapter titles and potentially previously generated summaries as additional context. The generated summary could then smoothly transition between chapters, summarizing the skipped content within the context of the chapter structure. This allows for a more natural and informative skip experience, even when jumping between large sections of the audiobook.

As another example, in implementations where the multimedia content is music, the example of FIGS. 4A-4D could be adapted by replacing the podcast segments with sections of a song. The multimedia content system can use the song's metadata (e.g., artist, song title, album, etc.) as content-based contextual signals. The generated summary could smoothly transition between sections, perhaps by creating a short instrumental interlude or by subtly altering the tempo or instrumentation. Further, user-based contextual signals, such as frequently skipped portions (e.g., a repetitive intro or outro), could be used to personalize the summary, potentially omitting these sections entirely from the generated summary.

As another example, in implementations where the multimedia content is a video, TV show, or movie, the example of FIGS. 4A-4D could be adapted by replacing the podcast segments with scenes or sequences from the video. Metadata associated with the video, TV show, or movie (e.g., actors in the video, TV show, or movie, awards won by the video, TV show, or movie, etc.) associated with the music acts as a content-based contextual signal, included in GM input to generate a more contextualized summary. Further, popular portions of the video, TV show, or movie, identified through user viewing data, can serve as a user-based contextual signal for generating a personalized summary. The generated summary might be a montage of key scenes or a narrated recap, seamlessly bridging the skipped content.

As another example, in implementations where the multimedia content is generative multimedia content, the different portion to which the user wishes to skip may not yet be generated. For example, assume that the multimedia content is a generative podcast that is based on an underlying technical paper, and the generative podcast is being rendered as it is being generated. In this example, and in response to receiving the indication to skip, the multimedia content system can process, using the GM, GM input that includes at least the underlying technical paper (e.g., in lieu of any intermediate portion of the generative podcast since the audio corresponding thereto has yet to be generated) to generate GM output, can determine the summary based on the GM output, and cause the summary to be rendered prior to resuming playback of the generative podcast. Notably, certain forms of content, such as technical papers, are usually arranged with different sections, sub-sections, headings, and/or other forms of logical or semantic markers. In this example, the multimedia content system can generate the summary based on these logical or semantic markers to see how far the user has indicated they wish to skip with respect to the underlying technical paper. Accordingly, even though there is no explicit intermediate portion of the generative podcast, techniques described herein can still be utilized to provide a summary of the content that is skipped.

Turning now to FIG. 5, a block diagram of an example computing device 510 that may optionally be utilized to perform one or more aspects of techniques described herein. In some implementations, one or more of a client device, remote system component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIGS. 1 and 2.

These software modules are generally executed by processor 514 alone or in combination with other processors. Memory 525 used in the storage subsystem 524 can include a number of memories including a main random-access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided and includes: receiving, during playback of multimedia content at a client device of a user, an indication to skip from a current portion of the multimedia content to a different portion of the multimedia content; processing, using a generative model (GM), GM input to generate GM output, the GM input including at least a corresponding segment of an intermediate portion of the multimedia content that is between the current portion of the multimedia content and the different portion of the multimedia content; determining, based on the GM output, a summary of the intermediate portion of the multimedia content; and causing the summary of the intermediate portion of the multimedia content to be rendered at the client device and prior to resuming playback of the multimedia content at the different portion of the multimedia content.

These and other implementations of technology disclosed herein can optionally include one or more of the following features.

In some implementations, the different portion of the multimedia content can be a future portion of the multimedia content that is subsequent to the current portion of the multimedia content and that has not yet been rendered during the playback of the multimedia content. The GM input can further include a corresponding segment of the future portion of the multimedia content.

In some versions of those implementations, the GM input can further include a corresponding segment of a previous portion of the multimedia content that is prior to the current portion of the multimedia content and that has already been rendered during the playback of the multimedia content.

In some implementations, the different portion of the multimedia content can be a previous portion of the multimedia content that is prior to the current portion of the multimedia content and that has already been rendered during the playback of the multimedia content. The GM input can further include a corresponding segment of the previous portion of the multimedia content.

In some versions of those implementations, the GM input can further include a corresponding segment of a future portion of the multimedia content that is subsequent to the current portion of the multimedia content and that has not yet been rendered during the playback of the multimedia content.

In some implementations, the indication to skip from the current portion of the multimedia content to the different portion of the multimedia content can be received via a scrub bar that is associated with the playback of the multimedia content at the client device and that is directed to a display of the client device. The scrub bar that is associated with the playback of the multimedia content at the client device can enable the user to skip to any desired portion of the multimedia content.

In some implementations, the indication to skip from the current portion of the multimedia content to the different portion of the multimedia content can be received via a tap gesture that is associated with the playback of the multimedia content at the client device and that is directed to a display of the client device. The tap gesture that is associated with the playback of the multimedia content at the client device can enable the user to skip to the different portion of the multimedia content by a predetermined interval of time or a semantic boundary of the multimedia content.

In some implementations, the method can further include, prior to processing the GM input to generate the GM output and using the GM, determining whether to cause the summary of the intermediate portion of the multimedia content to be rendered at the client device and prior to resuming playback of the multimedia content at the different portion of the multimedia content. Processing the GM input to generate the GM output and using the GM can be in response to determining to cause the summary of the intermediate portion of the multimedia content to be rendered at the client device and prior to resuming playback of the multimedia content at the different portion of the multimedia content.

In some versions of those implementations, determining to cause the summary of the intermediate portion of the multimedia content to be rendered at the client device and prior to resuming playback of the multimedia content at the different portion of the multimedia content can be based on determining that content of the intermediate portion of the multimedia content is related to one or more of: the current portion of the multimedia content, or the different portion of the multimedia content.

In some implementations, the GM input can further include one or more user-based contextual signals for a corresponding segment of the intermediate portion of the multimedia content that is between the current portion of the multimedia content and the different portion of the multimedia content. The one or more user-based contextual signals can be determined based on consumption of the multimedia content by a plurality of users. Further, the one or more user-based contextual signals for the corresponding segment of the intermediate portion of the multimedia content can include one or more of: popularity of the corresponding segment of the intermediate portion of the multimedia content, comments related to the corresponding segment of the intermediate portion of the multimedia content, clickthrough rate of the corresponding segment of the intermediate portion of the multimedia content, likes or shares of the corresponding segment of the intermediate portion of the multimedia content, or views of the corresponding segment of the intermediate portion of the multimedia content.

In some implementations, the GM input can further include one or more content-based contextual signals for a corresponding segment of the intermediate portion of the multimedia content that is between the current portion of the multimedia content and the different portion of the multimedia content. The one or more content-based contextual signals can be provided by a creator or publisher of the multimedia content. Further, the one or more content-based contextual signals for the corresponding segment of the intermediate portion of the multimedia content can include one or more of: chapterization of the corresponding segment of the intermediate portion of the multimedia content, or metadata associated with the corresponding segment of the intermediate portion of the multimedia content.

In some implementations, the method can further include: determining, based on the intermediate portion of the multimedia content, one or more queries for utilization in obtaining corresponding content that is relevant to the intermediate portion of the multimedia content; and obtaining, based on submitting one or more of the queries, the corresponding content that is relevant to the intermediate portion of the multimedia content.

In some versions of those implementations, the method can further include selecting, based on the corresponding content that is relevant to the intermediate portion of the multimedia content, the corresponding segment of the intermediate portion of the multimedia content to include in the GM input.

In additional or alternative versions of those implementations, the method can further include selecting, based on the corresponding content that is relevant to the intermediate portion of the multimedia content, all of the intermediate portion of the multimedia content to include in the GM input.

In additional or alternative versions of those implementations, the corresponding content that is relevant to the intermediate portion of the multimedia content can be utilized to verify content of the corresponding segment of the intermediate content of the multimedia content that is included in the GM input as factual information. The GM input can further include the corresponding content that is relevant to the corresponding segment of the intermediate portion of the multimedia content.

In additional or alternative versions of those implementations, the corresponding content that is relevant to the intermediate portion of the multimedia content can be utilized to identify the corresponding segment of the intermediate content of the multimedia content that is included in the GM input as trending information. The GM input can further include the corresponding content that is relevant to the corresponding segment of the intermediate portion of the multimedia content.

In some implementations, the multimedia content can be generative audio content or generative audio-visual content that was generated using the GM or an additional GM that is in addition to the GM. The summary of the intermediate portion of the multimedia content can include generative summary audio content or generative summary audio-visual content.

In some versions of those implementations, the GM input can further include a corresponding segment of reference information that was utilized by the GM or the additional GM in generating the generative audio content or the generative audio-visual content.

In some implementations, the multimedia content can be non-generative audiobook content, and the summary of the intermediate portion of the multimedia content can include an audible summary of the non-generative audiobook content that was skipped.

In some versions of those implementations, the GM input can further include a chapterization of the non-generative audiobook.

In some implementations, the multimedia content can be non-generative music content, and the summary of the intermediate portion of the multimedia content can include a musical summary of the non-generative audio-visual content that was skipped.

In some versions of those implementations, the GM input can further include metadata associated with the non-generative music content.

In some implementations, the multimedia content can be non-generative audio-visual content, and the summary of the intermediate portion of the multimedia content can include an audio-visual montage of the non-generative audio-visual content that was skipped.

In some versions of those implementations, the GM input can further include metadata associated with the non-generative audio-visual content.

In some implementations, the method can further include, in response to receiving the indication to skip from the current portion of the multimedia content to the different portion of the multimedia content: causing one or more graphical user interface (GUI) controls to be rendered at a display of the client device to enable the user to specify one or more features of the summary of the intermediate portion of the multimedia content. The one or more features of the summary of the intermediate portion of the multimedia content can include one or more of: a length of the summary of the intermediate portion of the multimedia content, a level of detail of the summary of the intermediate portion of the multimedia content, or a modality of the summary of the intermediate portion of the multimedia content.

In some implementations, the multimedia content may have been previously segmented prior to the playback of the multimedia content to determine one or more features of the multimedia content, wherein the GM input further includes one or more of the features of the multimedia content. The features of the multimedia content can include one or more of: timestamps associated with certain portions of the multimedia content, chapterizations of the multimedia content, captions associated with the multimedia content, speaker identification of one or more speakers included in the multimedia content.

In some implementations, the multimedia content may not have been segmented prior to the playback of the multimedia content, and the method can further include: determining one or more features of the multimedia content, wherein the GM input further includes one or more of the features of the multimedia content. The features of the multimedia content can include one or more of: timestamps associated with certain portions of the multimedia content, chapterizations of the multimedia content, captions associated with the multimedia content, speaker identification of one or more speakers included in the multimedia content.

In some implementations, the multimedia content can be stored in a multimedia content buffer of the client device.

In some implementations, the GM can be an on-device GM that is executed locally at the client device.

In some implementations, the GM can be a remote GM that is executed remotely from the client device.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform operations of any of the aforementioned methods. Some implementations also include a computer program product including instructions executable by one or more processors to perform operations of any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving, during playback of multimedia content at a client device of a user, an indication to skip from a current portion of the multimedia content to a different portion of the multimedia content;
processing, using a generative model (GM), GM input to generate GM output, the GM input including at least a corresponding segment of an intermediate portion of the multimedia content that is between the current portion of the multimedia content and the different portion of the multimedia content;
determining, based on the GM output, a summary of the intermediate portion of the multimedia content; and
causing the summary of the intermediate portion of the multimedia content to be rendered at the client device and prior to resuming playback of the multimedia content at the different portion of the multimedia content.

2. The method of claim 1, wherein the different portion of the multimedia content is a future portion of the multimedia content that is subsequent to the current portion of the multimedia content and that has not yet been rendered during the playback of the multimedia content, and wherein the GM input further includes a corresponding segment of the future portion of the multimedia content.

3. The method of claim 2, wherein the GM input further includes a corresponding segment of a previous portion of the multimedia content that is prior to the current portion of the multimedia content and that has already been rendered during the playback of the multimedia content.

4. The method of claim 1, wherein the different portion of the multimedia content is a previous portion of the multimedia content that is prior to the current portion of the multimedia content and that has already been rendered during the playback of the multimedia content, and wherein the GM input further includes a corresponding segment of the previous portion of the multimedia content.

5. The method of claim 2, wherein the GM input further includes a corresponding segment of a future portion of the multimedia content that is subsequent to the current portion of the multimedia content and that has not yet been rendered during the playback of the multimedia content.

6. The method of claim 1, wherein the indication to skip from the current portion of the multimedia content to the different portion of the multimedia content is received via a scrub bar that is associated with the playback of the multimedia content at the client device and that is directed to a display of the client device, and wherein the scrub bar that is associated with the playback of the multimedia content at the client device enables the user to skip to any desired portion of the multimedia content.

7. The method of claim 1, wherein the indication to skip from the current portion of the multimedia content to the different portion of the multimedia content is received via a tap gesture that is associated with the playback of the multimedia content at the client device and that is directed to a display of the client device, and wherein the tap gesture that is associated with the playback of the multimedia content at the client device enables the user to skip to the different portion of the multimedia content by a predetermined interval of time or a semantic boundary of the multimedia content.

8. The method of claim 1, further comprising:
prior to processing the GM input to generate the GM output and using the GM:
determining whether to cause the summary of the intermediate portion of the multimedia content to be rendered at the client device and prior to resuming playback of the multimedia content at the different portion of the multimedia content; and
wherein processing the GM input to generate the GM output and using the GM is in response to determining to cause the summary of the intermediate portion of the multimedia content to be rendered at the client device and prior to resuming playback of the multimedia content at the different portion of the multimedia content.

9. The method of claim 8, wherein determining to cause the summary of the intermediate portion of the multimedia content to be rendered at the client device and prior to resuming playback of the multimedia content at the different portion of the multimedia content is based on determining that content of the intermediate portion of the multimedia content is related to one or more of: the current portion of the multimedia content, or the different portion of the multimedia content.

10. The method of claim 1, wherein the GM input further includes one or more user-based contextual signals for a corresponding segment of the intermediate portion of the multimedia content that is between the current portion of the multimedia content and the different portion of the multimedia content, wherein the one or more user-based contextual signals are determined based on consumption of the multimedia content by a plurality of users, and wherein the one or more user-based contextual signals for the corresponding segment of the intermediate portion of the multimedia content comprise one or more of: popularity of the corresponding segment of the intermediate portion of the multimedia content, comments related to the corresponding segment of the intermediate portion of the multimedia content, clickthrough rate of the corresponding segment of the intermediate portion of the multimedia content, likes or shares of the corresponding segment of the intermediate portion of the multimedia content, or views of the corresponding segment of the intermediate portion of the multimedia content.

11. The method of claim 1, wherein the GM input further includes one or more content-based contextual signals for a corresponding segment of the intermediate portion of the multimedia content that is between the current portion of the multimedia content and the different portion of the multimedia content, wherein the one or more content-based contextual signals are provided by a creator or publisher of the multimedia content, and wherein the one or more content-based contextual signals for the corresponding segment of the intermediate portion of the multimedia content comprise one or more of: chapterization of the corresponding segment of the intermediate portion of the multimedia content, or metadata associated with the corresponding segment of the intermediate portion of the multimedia content.

12. The method of claim 1, further comprising:
determining, based on the intermediate portion of the multimedia content, one or more queries for utilization in obtaining corresponding content that is relevant to the intermediate portion of the multimedia content; and
obtaining, based on submitting one or more of the queries, the corresponding content that is relevant to the intermediate portion of the multimedia content.

13. The method of 12, further comprising:
selecting, based on the corresponding content that is relevant to the intermediate portion of the multimedia content, the corresponding segment of the intermediate portion of the multimedia content to include in the GM input.

14. The method of 12, further comprising:
selecting, based on the corresponding content that is relevant to the intermediate portion of the multimedia content, all of the intermediate portion of the multimedia content to include in the GM input.

15. The method of claim 12, wherein the corresponding content that is relevant to the intermediate portion of the multimedia content is utilized to verify content of the corresponding segment of the intermediate content of the multimedia content that is included in the GM input as factual information, and wherein the GM input further includes the corresponding content that is relevant to the corresponding segment of the intermediate portion of the multimedia content.

16. The method of claim 12, wherein the corresponding content that is relevant to the intermediate portion of the multimedia content is utilized to identify the corresponding segment of the intermediate content of the multimedia content that is included in the GM input as trending information, and wherein the GM input further includes the corresponding content that is relevant to the corresponding segment of the intermediate portion of the multimedia content.

17. The method of claim 1, wherein the multimedia content was previously segmented prior to the playback of the multimedia content to determine one or more features of the multimedia content, wherein the GM input further includes one or more of the features of the multimedia content, and wherein the features of the multimedia content comprise one or more of: timestamps associated with certain portions of the multimedia content, chapterizations of the multimedia content, captions associated with the multimedia content, speaker identification of one or more speakers included in the multimedia content.

18. The method of claim 1, wherein the multimedia content is not segmented prior to the playback of the multimedia content, and where the method further comprises:
determining one or more features of the multimedia content, wherein the GM input further includes one or more of the features of the multimedia content, and wherein the features of the multimedia content comprise one or more of: timestamps associated with certain portions of the multimedia content, chapterizations of the multimedia content, captions associated with the multimedia content, speaker identification of one or more speakers included in the multimedia content.

19. A system comprising:
at least one processor; and
memory storing instructions that, when executed by the at least one processor, cause the at least one processor to be operable to:
receive, during playback of multimedia content at a client device of a user, an indication to skip from a current portion of the multimedia content to a different portion of the multimedia content;
process, using a generative model (GM), GM input to generate GM output, the GM input including at least a corresponding segment of an intermediate portion of the multimedia content that is between the current portion of the multimedia content and the different portion of the multimedia content;
determine, based on the GM output, a summary of the intermediate portion of the multimedia content; and
cause the summary of the intermediate portion of the multimedia content to be rendered at the client device and prior to resuming playback of the multimedia content at the different portion of the multimedia content.

20. A non-transitory computer-readable storage medium storing computer-readable instructions that, when executed by at least one processor, cause the at least one processor to execute the computer-readable instructions to:
receive, during playback of multimedia content at a client device of a user, an indication to skip from a current portion of the multimedia content to a different portion of the multimedia content;
process, using a generative model (GM), GM input to generate GM output, the GM input including at least a corresponding segment of an intermediate portion of the multimedia content that is between the current portion of the multimedia content and the different portion of the multimedia content;
determine, based on the GM output, a summary of the intermediate portion of the multimedia content; and
cause the summary of the intermediate portion of the multimedia content to be rendered at the client device and prior to resuming playback of the multimedia content at the different portion of the multimedia content.
